(19) United States
(12) Patent Application Publication
(10) Pub. No.: US 2026/0084564 A1
(43) Pub. Date: Mar. 26, 2026

(54) MOBILE CHARGING STATION AND METHOD FOR CHARGING ELECTRIC VEHICLES IN A MOBILE MANNER

(71) Applicant: UZE BV, Mortsel (BE)

(72) Inventors: Kris VERDONCK, Mortsel (BE); Dieter SCHOTTE, Mortsel (BE)

(21) Appl. No.: 19/103,320

(22) PCT Filed: Aug. 11, 2023
(86) PCT No.: PCT/EP2023/072323

§ 371 Date: Feb. 12, 2025

(30) Foreign Application Priority Data
Aug. 12, 2022 (BE) 2022/5631

(51) Int. Cl. B60L 53/57; B60L 53/10; B60L 53/16; B60L 53/302; B60L 53/53; B60L 53/66

(52) U.S. Cl. CPC B60L 53/57; B60L 53/11; B60L 53/16; B60L 53/302; B60L 53/53; B60L 53/66; B60L 2210/10

(57) ABSTRACT

The present invention discloses a mobile charging station configured to fast-charge electric vehicles (EVs) with limited access to public or private charging points and comprises an energy accumulation group, a converter unit, charge controllers and an interface. The present invention pertains to the technical field of charging stations. In a second aspect, the present invention relates to a method for charging EVs in a mobile manner.

### FIELD OF THE INVENTION

The present invention discloses a mobile charging station configured to fast-charge electric vehicles (EVs) with limited access to public or private charging points and comprises an energy accumulation group, a converter unit, charge controllers and an interface. The present invention pertains to the technical field of charging stations.

In a second aspect, the present invention relates to a method for charging EVs in a mobile manner.

### BACKGROUND

Electric Vehicles (EVs) are becoming increasingly popular as many cities are enforcing stricter environmental laws, phasing-out access for cars powered by fossil fuels and envisioning cities with no emissions from engine exhausts for example using zero-emission zones. However, an implementation of such phase-out of fossil fuel vehicles is difficult to practically implement. A key role is played by the necessary charging infrastructure for charging these EVs. Public parking spaces often don't have the space to put public chargers, while the installation of charging infrastructure in private apartment buildings need formal support and approval from the majority of owners of these apartments. Dense mobility areas, such as large parking lots, also have difficulties with the implementation of adequate charging infrastructure. It requires a considerable financial investment, and the parking lot may be closed for a long period during the installation works. It's clear that developing and installing charging infrastructure needs a lot of noses pointing in the same direction. Therefore, there is currently a lack of chargers in many cities, although the use of EVs is still being stimulated. Specifically, there is a lack of direct-current fast charging (DCFC) stations, which allow an EV to charge at rates from 50 kW to 500 kW, or even higher. This is convenient for the EV driver as he does not have to wait hours for his EV to be charged. DCFC stations are an important key to mass adoption of EVs, as it helps EV drivers with range anxiety, which is the driver's fear that his vehicle has insufficient energy storage to cover the road distance needed to reach its intended destination. However, DCFC stations are expensive and only installable on certain locations, as they are physically bigger and need large medium voltage cabins to feed these stations.

U.S. Pat. No. 10,399,461B1 describes a method for charging EVs with a mobile charger, in which the mobile charger can be controlled autonomously or via a remote control. However, this known method only uses AC charging and has the disadvantage that DC fast charging is not possible and thus leads to longer charging times.

U.S. Pat. No. 9,369,082B2 describes a mobile charging system which includes a foldable solar panel and a battery. The system is transportable and is set-up nearby an EV to be charged. However, this known device can only charge its battery by the solar panels and does not have the ability to charge its battery by an external fast-charging point. This is a disadvantage for the flexibility of this known device, as it's not rechargeable at night.

In light of the above, an object of this invention is therefore to propose a mobile charging system for electric vehicles which is flexible and makes it possible to charge different types of electric vehicles quickly, allowing adequate energy storage. Another object of this invention is to propose a method for charging electric vehicles in a mobile manner, which allows more efficient charging of electric vehicles, to allow the creation of mobile charging services, to overcome the shortcomings of fixed public or private charging points, thereby facilitating the mass-adoption of electric vehicles.

### SUMMARY OF THE INVENTION

According to a first aspect of the invention, a mobile charging station, configured to charge one or more electric vehicles (EVs) is provided. The mobile charging station comprises:
an energy accumulation group, comprising accumulators for storing energy, and a dedicated accumulator management system;
a converter unit, connected to a direct-current (DC) bus and said accumulators, comprising one or more DC-DC converters, for converting a source of direct current from a first voltage level to a second voltage level, the second voltage level different from the first voltage level, whereby a dedicated control system, connected to said converter unit, is adapted to control the operation of said converter unit;
a station charge controller, whereby said station charge controller is configured as a communication module between said EV and said accumulator management system, whereby said station charge controller reads data from said EVs and/or writes data to said EVs and thereby allows said mobile charging station to recharge said EV; and
one or more interfaces, connected to said station charge controller, whereby said interface is configured for connecting a DC charging plug;
   characterized in that said mobile charging station further comprises an EV charge controller, whereby said EV charge controller is connected to said interface, whereby said EV charge controller functions as a communication module between an external charging point and said converter unit, whereby said EV charge controller reads data from said external charging point and/or writes data to said external charging point and thereby prompts said external charging point to recharge said mobile charging station based on said data.

In a preferred embodiment, the charging station comprises a heat management system for cooling at least the energy accumulation group, wherein said energy accumulation group comprises a niobium-titanium and/or lithium-titanium based battery, preferably lithium-titanate and/or niobium-titanate.

In a second aspect, the present invention relates to a method according to claim 13. More particular, a method is provided for operating a mobile charging station. The method comprises the following steps:
automatically assigning said mobile charging station to an electric vehicle;
transporting the mobile charging station to said electric vehicle, and charging said electric vehicle;
retrieving information regarding available proximal charging points, said information comprising location and availability of said charging points;
recharging said mobile charging station;
   wherein said mobile charging station is recharged at one of said charging points.

In a third aspect, the invention relates to a method for recharging a mobile charging station according to the first aspect, wherein the station comprises an internal cooling circuit for circulating a liquid coolant, wherein said internal cooling circuit contacts at least a heat sink of the energy accumulation group, wherein the internal cooling circuit comprises a coolant inlet port and a coolant outlet port on the exterior of the mobile charging station, comprising a step of:
a. electrically connecting the mobile charging station to a fixed charging point;
b. connecting the coolant inlet port and the coolant outlet port to a coolant supply system of the fixed charging point;
c. recharging the energy accumulation group of the mobile charging station by the fixed charging point;
d. circulating a refrigerated coolant by the coolant supply system through the internal cooling circuit;
e. removing coolant from the internal cooling circuit and subsequently disconnecting the coolant inlet port and the coolant outlet port from the coolant supply system;
f. disconnecting the mobile charging station from the fixed charging point.

In a fourth aspect, the invention relates to a method for scheduledly charging a plurality of electric vehicles (EVs) with a mobile charging station according to the first aspect, comprising the steps of:
a. electrically connecting the mobile charging station to a first of the EVs;
b. recharging the first of the EVs by the mobile charging station according to an optimized charge speed;

The optimized charge speed is determined based on at least the following features: an internal temperature of the mobile charging station, preferably at or near the energy accumulation group and/or at or near the converter unit; an increase rate in the internal temperature; a charge plan, comprising information on the plurality of EVs to be charged in a predetermined time span and the amount of energy to be charged per EV to be charged; preferably an outside temperature, and more preferably a projected outside temperature in the predetermined time span; preferably EV maximal charge speed information. The optimized charge speed is modified to maintain the internal temperature below a predefined maximum temperature over the predetermined time span.

In a fifth aspect, the invention relates to a method for charging a plurality of mobile charging stations according to the first aspect at a fixed charging point, the method comprising the steps of:
a. connecting the plurality of the mobile charging stations in series with each other, with the first mobile charging station in the series being connected to the fixed charging point;
b. charging the plurality of the mobile charging stations in the series according to a predetermined schedule, wherein the first mobile charging station is charged by the charging point, and wherein one or more of the mobile charging stations charge subsequent mobile charging station in the series, departing from the charging point, according to the predetermined schedule.

### DESCRIPTION OF FIGURES

FIG. 1 shows a schematic representation of the mobile charging station according to an embodiment of the invention.

FIG. 2 shows a general reprentation of a mobile charging station according to an embodiment of the invention while charging an electric vehicle.

### DETAILED DESCRIPTION OF THE INVENTION

The present invention concerns a mobile charging station, which is configured to charge electric vehicles (EVs) who have limited access to fixed public or private charging points. This can be the case in densely populated cities or in big parking lots where there is not enough charging infrastructure foreseen, or the existing charging infrastructure is fully occupied by other EVs. More specifically, the invention is created to allow the charging of any type of electric vehicle fully off-grid located in any place, allowing for a fast charge. The mobile charging station uses a local battery pack and, thus, eliminates the need for a combustion-based generator or wired electrical connections to utility power grids. Manual configurations may be sufficiently compact, lightweight, and demobilized to enable a single adult of average height and weight to transport the mobile charging station within a city or parking lot, for instance assisted by a trolley or the like on which the system can be supported. One of the major advantages of the present invention lies in the specifically chosen weight range in which it works, namely at least 200 kg, allowing it to have a sufficiently high capacity as well as high enough charging speed, and at most 500 kg, meaning it can be deployed via micro-mobility means, for instance cargo-bikes, e-scooters, personal transporter, Segway, electric rollerblades, e-step, etc. This is particularly advantageous over other means, as it allows a rapid deployment in urban areas, where ‘heavy’ charging stations that are transported in a van or the like, fall victim to congestion and traffic, road works, etc., while micro-mobility offers the perfect solution of being able to transport mid-heavy weight charging stations as in the present invention, while being maneuverable enough to avoid the ‘normal traffic’ pitfalls. Deployable and shareable mobile charging stations furthermore eliminate the associated cost, maintenance, installation time and dedicated space for fixed grid charging points. Another advantage may be the charging of the mobile charging station during off-peak hours of the day and discharging said mobile charging station during peak hours, so to avoid peak-demand penalties from the grid operator. With the present invention, the reliance on public electric grids is eliminated. To parking area owners, these mobile charging stations may be shared amongst multiple vehicles and transported between multiple lots. To EV owners, these mobile charging stations offer increased driving range with reduced range anxiety by enabling widespread charger distribution.

Aspects of this disclosure concerns direct current fast charging (DCFC), by a battery pack, for recharging EVs. In an example, a mobile charging station is presented that includes a rigid frame supported on multiple drive wheels and which can be transported by a dedicated carrier (for example a cargo bike). Also mounted to the frame is one or more electrical interfaces, such as a plug-in electrical connector or electromagnetic wireless charging pad, that operatively connects the battery pack to an EV. Also presented herein are control algorithms and processing logic for making or for deploying any of the mobile charging stations. In an example, a method is presented for deciding to recharge a mobile charging station to a public charging point or a charging hub.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment. “About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed. “Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥24, ≥5, ≥6 or ≥7 etc. of said members, and up to all said members.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

“Electric vehicle” (EV) is defined herein as meaning a vehicle for which at least some of the energy for moving the vehicle is derived from an onboard stored electric power supply such as a battery and/or a capacitor. Examples of electric vehicles include, but are not limited to, a battery electric vehicle, a capacitor electric vehicle, a hybrid electric vehicle, and a plug-in hybrid electric vehicle.

“Mobile” is defined herein as meaning capable of moving and/or being moved and is not fixed to one position or place, but optionally may be attached to a flexible connection such as an electric power line, a fuel line, an information transfer line, or combinations thereof.

“Battery” refers to any electrochemical cell capable of storing charged particles (such as electrons and/or protons) and/or generating a current of electrons (such as from ion exchange due to a reduction/oxidation reaction in the battery). The terms “battery,” “rechargeable-battery,” “charge storage device,” “electrochemical cell,” “power pack,” “battery stack,” and similar terms may be used interchangeably, according to some example embodiments of the present invention, to refer to means of generating and/or storing electrical charge

In a first aspect, the invention provides a mobile charging station, configured to charge (one or more) electric vehicles (EVs), comprising
an energy accumulation group, comprising accumulators for storing energy and a dedicated accumulator management system;
a converter unit, connected to a direct-current bus and said accumulators, comprising one or more DC-DC converters, for converting a source of direct current from a first voltage level to a second voltage level, the second voltage level different from the first voltage level, whereby a dedicated control system, connected to said converter unit, is adapted to control the operation of said converter unit;
a station charge controller, whereby said station charge controller is configured as a communication module between said EVs and said accumulators, whereby said station charge controller is configured to act as a charging point simulator, whereby said charging point simulator reads data from said EVs and/or writes data to said EVs;
one or more interfaces, connected to said station charge controller, whereby said interface is configured for connecting a DC charging plug;
   characterized in that said mobile charging station further comprises an EV charge controller, whereby said EV charge controller is connected to said interface, whereby said EV charge controller functions as a communication module between an external charger and said converter unit and whereby said EV charge controller is configured to act as an EV simulator and whereby said EV simulator reads data from said external charger and/or writes data to said external charger, and can prompt the external charge to recharge the mobile charging station.

The energy accumulation group comprises a plurality of accumulators, preferably rechargeable batteries, built up in a battery pack with a battery management system (BMS). The individual batteries may be configured in a series, parallel or a mixture of both in the battery pack, to deliver the desired voltage, capacity, or power density. In this case, the inventors chose to design a battery pack which allows for high charging rates in order to enable fast charging, while not losing out on the lifespan of the battery pack. The BMS is essential to protect the battery from damaging itself, for example during overcharge or overdischarge, while controlling the charge and discharge rate and constantly monitoring its state (e.g. voltage and temperature). The BMS is preferably equipped with a Controller Area Network (CAN) communication and a dedicated CAN connector. Preferably, the battery pack output voltage ranges from 800V to 400V depending on the state of charge (SoC). Preferably, the battery pack is designed to withstand 20.000 or more charge and discharge cycles. Preferably, the battery pack is usable at temperature of −30° C. to +40° C. and up until a height of preferably 2000 m above sea level. Advantageously according to the invention, said accumulators can be arranged in a rack configuration. Preferably, the battery pack is fitted in a water-proof enclosure or housing.

Preferably, the battery pack is designed with lithium-titanate batteries Li₂TiO₃, which allow for a charging rate of up to 10C and 20.000 charge or discharge cycles. An important factor is to minimize the influence of temperature on the battery pack. In this example, the battery pack is operational between −30° C. and +55° C. Another important factor is to minimize risk and danger on short circuit or penetration. The voltage of the battery pack is 730V when fully charged and 410V when empty. The battery pack has preferably a capacity of 3.5 kWh, more preferably at least 7 kWh, more preferably at least 12 kWh, more preferably at least 18 kWh, more preferably at least 28 kWh, even more preferably at least 35 kWh, even more preferably at least 40 kWh.

The converter unit comprises a DC-DC converter, preferably two DC-DC converters, which is preferably a bidirectional converter, and converts the voltage from the battery pack to the correct voltage required by the EV. While discharging the battery pack, its voltage slowly decreases and drops significantly after a long discharge time. Therefore, it is important that a steady output voltage for the EV is maintained, in order not to damage the battery pack in the EV. The converter unit also houses a converter control module, which regulates the output voltage for a given input voltage. The converter control module communicates with the BMS. The converter unit preferably uses Silicon-Carbide (SIC) switching technology, to allow for faster switching and consequently a better efficiency. It is preferably controlled by the CAN-bus protocol and is as lightweight as possible. Preferably, the DC voltage of said DC-DC converter ranges from 0 to 800 V_{DC}, more preferably from 0 to 1000 V_{DC}.

The station charge controller is an electric vehicle supply equipment (EVSE) and is connected to the EV via an interface, preferably a DC plug-in interface, and communicates with the EV and the BMS. Essentially, the objective of the station charge controller is to simulate a charging point. For the EV, there is consequentially no difference between being connected to a public/private charging point or the mobile charging station. This is possible because the station charge controller supplies all necessary parameters and data from the EV to the BMS and vice versa, such as, but not limited to battery pack voltage, State of Charge (SoC), current, power, State of Health (SoH), temperature, charging and discharging rates, cycles. The mobile charging station delivers DC current directly to the battery of the EV, e.g. bypassing the on-board charger. Charging of the electric vehicle is done in mode 4, type CHAdeMO and CCS Combo, according to IEC standard 61851-1. In mode 4, power delivered by DC charging stations ranges from 24 kW to more than 900 kW with a Combo CCS connector, and up to 400 kW with a CHAdeMO connector. In mode 4, the digital communication between the EV and the EVSE (station charge controller) complies with the requirements described in IEC 61851-24.

The EV charge controller is connected to a charging point via an interface, preferably a DC plug-in interface, and communicates directly with the charging point and the converter control module. Essentially, the objective of the EV charge controller is to simulate an EV. For the charging point, there is consequentially no difference between being connected to an EV or the mobile charging station. The EV charge controller supplies all necessary data and parameters to simulate an EV being connected to the charging point.

The mobile charging station also comprises one or more electrical interfaces for wired charging of an EV via a plug-in connector, preferably a DC plug-in connector, which may be one of several different commercially available electrical connector types, preferably of the type CCS. By way of non-limiting example, the charging connector may be designed to meet the standards set forth in IEC 62196-2 and/or IEC 62196-3, as well as any other presently available or hereinafter developed standards. A charge port, accessible on the exterior of the vehicle body functions as an electrical inlet into which the connector can be plugged in. The interfaces are located on the housing. The housing should be light, strong and electrically compliant (electric insulation for areas which are high impact risk areas).

For the sake of simplicity, both station charge controller and EV charge controller will hereafter be called charge controllers. The charge controllers may be programmable. The charge controllers are configured to comply with the CCS (Combined Charging System) requirements according to DIN SPEC 70121 and ISO 15118 or CHAdeMO protocol and are therefore compatible with most EVs. The communication is done by the latest automotive standards and is possible in a wired or wireless way, preferably by CAN bus protocol. Both charge controllers have a logging system, which is connected to a cloud or server via 4G or similar communication protocols. The logging system can be used to analyze data and optimize the mobile charging station.

The implementation of said EV charge controller in the present invention makes it possible for the mobile charging station to charge multiple EVs in a very flexible way as the mobile charging station can simulate itself as an EV, it is able to recharge at public or private charging points. This is beneficial for the following reason: the mobile charging station does not necessarily need to return to a central hub for charging. Even though the hub is usually centrally located, if the next EV that needs to be charged is located near the last EV, it is time consuming to return to the hub in order to recharge and travel the same route back to the new EV. Therefore, being able to recharge at existing charging points—preferably on a route from the last EV to the new EV—is timesaving and consequently more efficient. The mobile charging station could always return to a hub, if the next EV is on a route which passes alongside the hub, or if no next EV is scheduled. In other words, the EV charge controller allows for a flexible operation of the mobile charging station.

In a preferred embodiment, the charging station comprises a heat management system for cooling at least the energy accumulation group, wherein said energy accumulation group comprises a niobium-titanium (preferably NTO or niobium-titanate) and/or lithium-titanium (preferably LTO or lithium-titanate) based battery. It should be noted that the goal of the invention is to provide for a compact station, making it easy to move in urban environments, without necessarily having to use a delivery van or a car. In this light, the weight and volume is limited, which affects the total energy capacity of the station directly, as well as the possibilities in terms of heat management, as free space is important for cooling down such components as the battery, and the converter unit.

In the invention, a specific choice was made towards less energy-dense batteries (NTO, LTO), which have a substantially lower energy-density than the types of batteries ( that are typically used for charging stations (where weight and volume are not so much of an issue, and the goal is to maximize the total energy capacity). The choice towards these battery types however provides for the advantage of allowing much faster charging speed (both charging EVs and recharging the batteries themselves). This is however accompanied by the undesirable side-effect of a much higher heat generation that needs to be addressed. If the temperature of the batteries, converter unit and other parts used for the energy transfer, rises, the charging speed/efficiency drops accordingly, or the charging process can even shut down entirely due to overheating.

While the compactness of the system as intended in the invention does not provide for enough natural cooling to accommodate the increased heat generation (due to limited free space), the provision of a dedicated heat management system for cooling at least the batteries, and preferably also the converter unit, provides for the necessary heat extraction to keep the temperature in an acceptable range that does not reduce energy transfer rate/efficiency too strongly. It should be noted that the heat management system itself provides for a drain on the energy supply in the station (typically on the batteries, although sometimes separate dedicated batteries are provided for the heat management system). This then creates further heat generation, while also reducing the available energy. As such, a delicate balance needs to be maintained between the charging speed, the ‘allowed’ internal temperature and the heat management actions taken, as they are interconnected and affect each other.

As such, the heat management system is used to generate an airflow inside of the mobile charging station, to extract hot air from the station, and replace it with cold(er) outside air. Preferably, this is achieved by one or more fans or similar air flow generating devices.

Most preferably, one or more air inlets and one or more air outlets are provided, putting the interior of the charging station in communication with the outside, with the air inlets being positioned at or near the bottom of the charging station and the air outlets towards the top. Internal ventilation units, such as fans, create the airflow inside of the charging station, from the air inlets to the air outlets, passing by the batteries in particular, and the converter unit (as well as other parts where heat accumulates).

The counter-intuitive choice for batteries with a lower energy density is in favor of a higher charging speed, and brings with it the need for a more finetuned heat management in the mobile charging station. Through this choice, the system is enabled for shorter, faster charging actions, without needing downtime to cool down. By furthermore choosing for a compact design, the space usage is optimized to maximize the energy capacity (which is reduced due to the choice for lower energy-density/higher charging speed battery types), trading in space necessary for cooling for space for batteries, and a part of that traded space also for a heat management system.

In a preferred embodiment, the present invention provides a converter unit configured to enable bidirectional charging, whereby either said energy accumulation group is charged by said external charging point or said energy accumulation group is discharged by said EV.

While conventional chargers only have a unidirectional flow of energy, more specifically from the electricity grid to the battery pack of the EV, the charger described in the present invention allows for a bidirectional energy flow. This is realized by a bidirectional converter unit, which can function as a buck or boost converter. As a boost converter, the converter allows for stepping up the output voltage. As a buck converter, the converter allows for stepping down the output voltage. This bidirectional system is particularly useful to downsize the system, as the system doesn't need two different converters, and therefore make it lighter which in turn is necessary to make the system mobile and easily transportable. The bidirectional converter could be of the isolated or non-isolated type.

In a preferred embodiment, the present invention comprises one or more switches whereby each switch is respectively connectable to said interface and to said direct-current bus, whereby said switches are configured to isolate or link said direct-current bus from said interfaces and whereby each switch is respectively controllable by said station charge controller or said EV charge controller.

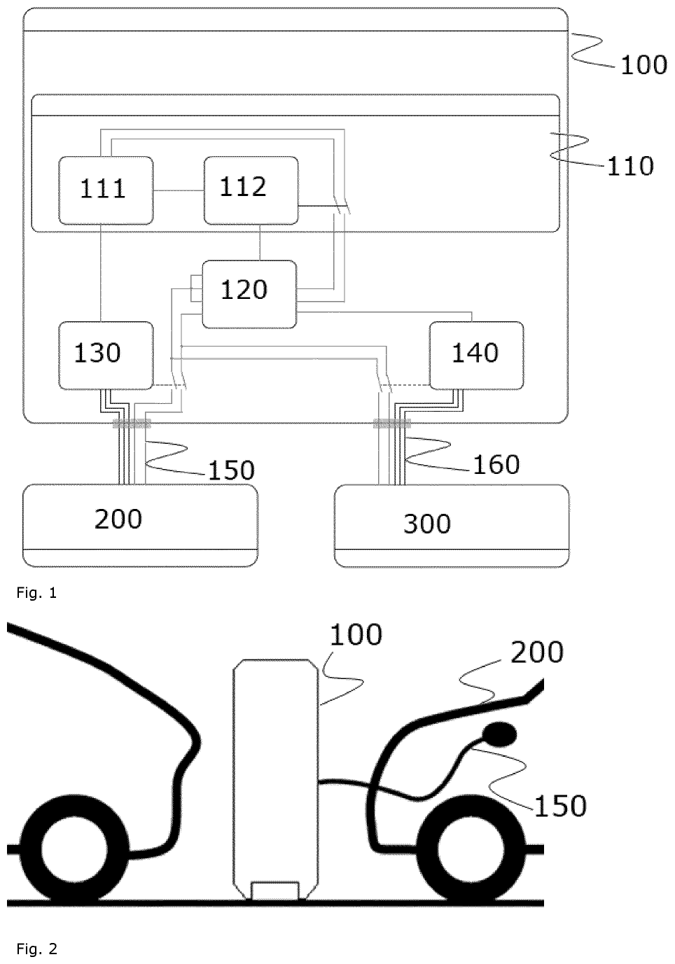

One switch or contactor is controlled by the station charge controller, wired or wirelessly, while the other switch is controlled by the EV charge controller. The switches can isolate the converter unit and thus battery pack from the interfaces, as can be seen in FIG. 1. When an EV is connected to the mobile charging station, the station charge controller reads and interprets the communication input from the EV such as battery temperature, state of charge, battery voltage, etc. and communicates these parameters to the BMS and the respective switch. When all parameters are checked and the EV is ready to be charged, a closing signal is sent to the switch, which allows the EV to be charged.

When the mobile charging station is connected to an external charging point, the EV charge controller will read the parameters from the charging point and write the internal parameters from the battery pack (BMS) to the charging point. After the parameters are analyzed by the charging point, the EV charge controller sends a closing signal to the respective switch, which allows the mobile charging station to be charged. It is of course still possible in the present invention to charge the mobile charging station via the AC grid. However, an external AC/DC-converter will be necessary in order to convert the AC voltage to a DC voltage. The advantages of the specific choice of using DC as input current results in a high increase in operating speed, allowing faster charging.

In a preferred embodiment, the present invention comprises an interface configured to receive a connector plug, preferably a DC connector, preferably of the type Combined Charging System (CCS) and whereby said connector plug is connectable to said EV or said external charger.

As already described, the present invention uses DC connector plugs, preferably CCS connectors. However, also CHAdeMO connectors could be used. One or more interfaces are integrated in the chassis of the mobile charging station. One interface is connected to the station charge controller and usable for plugging into an EV and charging said EV, while the other interface is connected to the EV charge controller and respectively usable for plugging into an external charging point and recharging its own battery. To avoid misuse or abuse, the connector plug cannot be undocked from the mobile charging station without unlocking the station first. This is done by an internal locking system.

In a preferred embodiment, the mobile charging station is suitable for being connected to an external charging point (for instance, a fast-charger) and an external unit-to-be-recharged. This would allow the EV charge controller and the station charge controller to communicate at the same time to respectively the external charging point and the external unit-to-be-recharged, thus prompting the external charging point to recharge the mobile charging station, and at the same time recharge the connected unit-to-be-recharged. This way, the mobile charging unit can, depending on the situation, act as a boost or buffer, in order to make maximized use the charging functionality of the external charging point. Many EVs act as a limiter for the external charging point, depending on their design, thus only enjoying a part of the maximal output of the external charging point. In such cases, the mobile charging station acts as a buffer, and can simultaneously charge the electric vehicle with the received power, while in turn recharging its own battery as well with the surplus of received power it can't “pass through” to the EV. Alternatively, if the external charging point is the limiting factor on a potential direct charging operation between charging point and EV, the mobile charging station can act as a boost, and offer the EV a higher (maximized) power, by making up for the deficit from its own stored power.

In a preferred embodiment, the present invention comprises an energy accumulation group of the type including rechargeable batteries, whereby said rechargeable batteries are preferably lithium-ion batteries, more preferably lithium-titanate Li₂TiO₃ batteries, which allow for a high charging rate.

By way of example only, and in no way meaning to limit the scope of this disclosure, other examples of suitable battery types that can be used include but are not limited to zinc-carbon, zinc-chloride, alkaline, nickel oxyhydroxide, lithium-containing, lithium-based, lithium-copper oxide, lithium-ion disulfide, lithium-manganese dioxide, lithium-carbon fluoride, lithium-chromium oxide, lithium-silicon, mercury oxide, zinc-air, Zamboni pile, silver oxide, magnesium, nickel-cadmium, lead-acid, nickel-metal hydride, nickel-zinc, silver-zinc, lithium-iron-phosphate, solid state batteries, aluminum air, other suitable chemistries and configurations, variants thereof, and any combination thereof.

In a preferred embodiment, the present invention is configured for charging at a power rate of minimum 5 kW DC, preferably at least 12 kW DC, more preferably at least 20 kW DC, even more preferably at least 28 kW DC, even more preferably at least 45 kW DC, even more preferably at least 56 kW DC, even more preferably at least 64 kW DC,, and whereby said charging station is configured as a direct-current fast charger (DCFC).

In a preferred embodiment, the interfaces are all combined into a single interface and whereby said interface is configured to act as an input and an output simultaneously.

As already mentioned, the interfaces are used as input, for charging the mobile charging station's battery or as output, for charging an EV. In a preferred way, these interfaces are combined in a single interface, therefore allowing only one DC connector to be necessary.

In a preferred embodiment, the present invention is fitted with a heat-extraction ventilator.

A ventilation system is fitted to the system to extract heat when charging or discharging the mobile charging station. The ventilation is located in the housing and preferably directed to the ground, for reasons such as rain and/or dust and/or dirt protection and vandalism protection.

In a preferred embodiment, the present invention comprises an interconnection recipient, whereby multiple charging stations are connectable in parallel by interconnecting said interconnection recipient from two or more of the multiple charging stations and whereby said charging stations can be charged simultaneously.

In a preferred embodiment, the present invention is configured to serve as (part of) an energy storage device, for example as a household home battery.

In a preferred embodiment, after its intended use, after a period of time, the battery pack can be deployed as an energy storage device. This is particularly interesting in the light of ecological and durable reasons. The present invention has the potential to serve as an energy storage point, for example solar energy, and deliver its stored energy to the grid for grid balancing or deliver its energy to a household when most needed as a household home battery.

In a preferred embodiment, the present invention in an upright position has a height of preferably more than 1 m, more preferably more than 1.3 m and whereby said charging station has a width of preferably less than 90 cm, more preferably less than 60 cm, most preferably less than 40 cm.

The optimized dimensions are in function of the optimal housing size, which must comply with several requirements. The housing should be visible from inside a car, or in other words higher than the average back window of a car. 1.3 m is a preferred height for the mobile charging station, so cars notice there is a charging station behind them. The housing should fit between two parked cars, thereby a width of 40 cm is preferred to ensure that cars can park out, but also to provide enough space for the mobile battery station to be dropped off. A length of 1.2 m is preferred so the housing is transportable a forklift truck.

In a preferred embodiment, the present invention comprises an interface panel, through which an operator or consumer can control the charging process, preferably a touch-screen display, whereby said interface panel displays charging parameters for example charging current, charging voltage, charging power, total energy transferred, estimated charging end time, total charging time. The operator or consumer can set some or all of the above parameters per their preferences.

According to the invention, said internal control system may comprise: an interface panel visible by means of a display, preferably a touch screen display, to highlight charging parameters such as kWh delivered, estimated charging end time, instantaneous power, and an interface board, intended to be connected, by means of a cable, to an analogous communication interface board of said electric vehicle whose rechargeable batteries must be charged, for detecting the charge state of said rechargeable batteries, said interface board being adapted to detect the operational information of said charging apparatus including: information relating to the electric charge and the temperature of said accumulators and related to the thermal and operating condition of said converter.

In a preferred embodiment, the mobile charging station comprises an internal cooling circuit for circulating a liquid coolant (for instance glycol/water, etc.), wherein said internal cooling circuit contacts at least a heat sink of the energy accumulation group, wherein the internal cooling circuit comprises a coolant inlet port and a coolant outlet port on the exterior of the mobile charging station. This internal cooling circuit allows for coolant to be introduced and circulated therein, cooling down the necessary components in the station. By using a closed circuit, there is no danger of damage to the charging station itself, and can be used to cool down the batteries, for instance via a heat sink of the batteries. The invention in this regard is also based on providing a central charging station or hub in which the mobile charging stations can be recharged at high speed, which normally would create issues in terms of heat generation, reducing the effective energy transfer speed. By providing a coolant supply system in or at said hub that can be connected to the coolant inlet and outlet ports, it can directly and strongly extract the generated heat, allowing the recharging of the mobile charging stations to happen at maximal (or at least, strongly increased) speed and with a higher efficiency.

By providing this at a central hub, it has the advantage of impacting the long recharging period, allowing it to be done at high speed, but also allows this to be done at a safe location. Additionally, it allows the charging jobs to be performed at increased efficiency, as the temperature can be pushed to a limit with the knowledge the mobile charging station can be cooled actively during recharging. Most importantly however, it means there is no added weight of a coolant in the mobile charging station during operation.

In a preferred embodiment, the mobile charging station comprises an outer frame and wherein all internal components are housed in a plurality of closed subframes, said outer frame housing a first closed subframe comprising the converter unit, a second closed subframe comprising the energy accumulation group, a third closed subframe comprising the station charge controller and the EV charge controller, and a fourth closed subframe comprising the one or more interfaces, wherein the closed subframes comprise one or more connectors and wherein each closed subframe is wiredly connected to at least one other of the closed subframes via said connectors. By compartmentalizing the components in groups, it provides a modularity to the system that simplifies the structure, allows easier repairs (and shipping of only deficient parts instead of a full station), increases safety (separating high-voltage from low-voltage and other parts), simplifies cooling by creating pathways, as well as enabling liquid cooling as described above, etc.

In a preferred embodiment, the mobile charging station comprises a control system configured for controlling charge speed of charging an EV, wherein the control system is configured for determining the charge speed based on at least the following features: an internal temperature of the mobile charging station, preferably at or near the energy accumulation group and/or at or near the converter unit; an increase rate in the internal temperature; a charge plan, comprising information on the amount of EVs to be charged in a predetermined time span, the amount of energy to be charged per EV to be charged; preferably an outside temperature, and more preferably a projected outside temperature in the predetermined time span; preferably EV maximal charge speed information. The charge speed is modified to maintain the internal temperature below a predefined maximum temperature over the predetermined time span.

Using the above information, the charge speed can be modified continuously or discretely (every X seconds or minutes). By doing so, overheating is avoided, or at least mitigated, and the heat build-up can be scheduled, taking into account the charge plan (for instance, allowing the temperature to slowly rise instead of maintaining a more or less constant temperature), the outside temperature (increasing charge speed if cooler temperatures are expected soon, or reducing the charge speed over the course of the day as the temperature outside typically increases), etc.

By doing so, the system is able to perform over its entire planned workload before recharging, and can allow the temperature to change during its operation.

For instance, the system can be configured to operate at a lower charging speed at the start of its schedule, since the internal temperature (and often also the outside temperature) will still be low and energy transfer will be efficient, thereby generating less heat. Then, towards the end of the schedule, when more heat will have built up, the internal temperature will be higher, reducing energy transfer efficiency, the charging speed can be increased (as will the heat generation), knowing that this is only for a short amount of time before the scheduled work is performed and the system can cool down (or be cooled down).

In a second aspect, the invention provides a method for operating a mobile charging station, comprising the following steps:
automatically assigning said mobile charging station to an electric vehicle;
transporting the mobile charging station to said electric vehicle, and charging said electric vehicle;
retrieving information regarding available proximal charging points, said information comprising location and availability of said charging points;
recharging said mobile charging station;
   wherein said mobile charging station is recharged at one of said charging points.

The method provides a mobile application as a management system. The customer is able to order one or more charging sessions for his EV, depending on the time and place, by a mobile app. From the nearest mobile battery hub, a courier is instructed to transport the mobile charging station to the EV's location. If desired, the courier connects it to the EV. The mobile battery hub is a collection point for mobile battery packs. These packs can be charged at this location if connection to an electricity grid is possible. However, an off-grid service point is also possible, where the hubs themselves can be moved to a charging location. Because of the car simulator, the mobile charging station is seen by an external charger as an EV. It therefore allows the mobile charging station to charge at an existing station

The mobile charging station may be equipped with a vehicle telecommunication and information unit that wirelessly communicates (e.g., via cell towers, base stations and/or mobile switching centers, etc.) with a cloud computing device or server. This computing device can be configured to maintain all data of the platform users (EV drivers and mobile charging station operators). Based upon available sources of charging, entities may need charging, and other relevant aspects and information related to the preparation and enactment of a charge transaction schedule. In other words, in some embodiments, the cloud computing environment or the like can use algorithms or other means for scheduling charge transactions between of heterogeneous or homogeneous mobile entities within a charging network.

The scheduling, commencement, and/or termination of, payment for, and record-keeping for charge transactions within a charging network or a plurality of charging networks can be governed by at least one or more centralized computing devices (e.g., a cloud). In some embodiments, the one or more computing devices can be configured to track the plurality of vehicles and dynamically authorize charging according to a charge-distribution map. In some embodiments, a computing device can, once, intermittently, or in real-time, generate the charge-distribution map, e.g., with the use of one or more scheduling algorithms. In some embodiments, if the computing device is a cloud computing environment in communication with a plurality of battery-powered vehicles or other battery-powered entities, the cloud can maintain an updated charge-distribution map, receive from the battery-powered entities updated GPS position, speed of travel, type of vehicle/entity, road/weather conditions, and other useful information, and employ an efficient charge scheduling algorithm to schedule charging instances between entities that are controllable within the system. In other words, the battery-powered vehicles transmit, e.g., in real-time, sufficient pertinent information to the cloud such that the cloud computing environment is able to use one or more charge-scheduling algorithms to schedule the next instances of charging between entities within the system and to update the charge-distribution map.

Charging as a service (CaaS) is an EV charging service where the customer pays a monthly, bimonthly, three-monthly, half-yearly or yearly subscription fee or variations thereof and avoids paying all the upfront costs of equipment, installation, and permitting for an electric fast charger.

According to a preferred method, said mobile charging station is recharged at a central charging hub, based on at least the distance between the location of said mobile charging station, the location of said charging points, the location of said central charging hub and the location of a possible next charging session.

According to a preferred method, said charging station is transported, discharged, or recharged autonomously.

In a particularly preferred embodiment, the charging station has to be as light as possible, as the charging station will be transported through a city by a dedicated carrier, but not too light to avoid displacements by other people on purpose or by accident. When configuring the system to allow fast charging, the components will need to be bigger and thus heavier. The inventors want to allow for charging at high power values, around 50 kW, which essentially means heavier equipment.

In another preferred embodiment, a mobile charging station could have one or more solar panels on its housing, thereby enabling the mobile charging station to be charged by solar energy.

In a third aspect of the invention, the invention relates to a method for recharging a mobile charging station according to any the first aspect, wherein the station comprises an internal cooling circuit for circulating a liquid coolant, wherein said internal cooling circuit contacts at least a heat sink of the energy accumulation group, wherein the internal cooling circuit comprises a coolant inlet port and a coolant outlet port on the exterior of the mobile charging station, comprising a step of:
a. electrically connecting the mobile charging station to a fixed charging point;
b. connecting the coolant inlet port and the coolant outlet port to a coolant supply system of the fixed charging point;
c. recharging the energy accumulation group of the mobile charging station by the fixed charging point;
d. circulating a refrigerated coolant by the coolant supply system through the internal cooling circuit;
e. removing coolant from the internal cooling circuit and subsequently disconnecting the coolant inlet port and the coolant outlet port from the coolant supply system;
f. disconnecting the mobile charging station from the fixed charging point.

As mentioned previously, the advantages of actively cooling the mobile charging station at a fixed charging point or hub are clear, in that it allows the recharging process to be performed at much higher speeds, it allows the mobile charging station to be pushed to its limits during charging jobs (with the knowledge it can be actively cooled during recharging), in safe conditions, while keeping the mobile charging station light (there is no coolant present when not at the hub).

In a fourth aspect, the invention relates to a method for scheduledly charging a plurality of electric vehicles (EVs) with a mobile charging station according to the first aspect, comprising the steps of:
a. electrically connecting the mobile charging station to a first of the EVs;
b. recharging the first of the EVs by the mobile charging station according to an optimized charge speed;

The optimized charge speed is determined based on at least the following features: an internal temperature of the mobile charging station, preferably at or near the energy accumulation group and/or at or near the converter unit; an increase rate in the internal temperature; a charge plan, comprising information on the plurality of EVs to be charged in a predetermined time span and the amount of energy to be charged per EV to be charged; preferably an outside temperature, and more preferably a projected outside temperature in the predetermined time span; preferably EV maximal charge speed information. The optimized charge speed is modified to maintain the internal temperature below a predefined maximum temperature over the predetermined time span.

In a fifth aspect, the invention relates to a method for charging a plurality of mobile charging stations according to the first aspect at a fixed charging point, the method comprising the steps of:
a. connecting the plurality of the mobile charging stations in series with each other, with the first mobile charging station in the series being connected to the fixed charging point;
b. charging the plurality of the mobile charging stations in the series according to a predetermined schedule, wherein the first mobile charging station is charged by the charging point, and wherein one or more of the mobile charging stations charge subsequent mobile charging station in the series, departing from the charging point, according to the predetermined schedule.

A specific advantage is the reduction in (expensive) necessary material at the fixed charging point, such as multiple connection ports, multiple cables, etc. The mobile charging station each already comprise a cable that allows them to be coupled electrically in series. This means the fixed charging point only needs one port (in theory), and (optionally) one cable for connecting to a first of the mobile charging stations in the series, which then uses its own cable to connect to the subsequent one, etc.

Of course, multiple such ports can be provided at a hub to partly parallelize the charging process and increase the charging speed, allowing the series to be split in multiple series of less mobile charging stations, to reduce down time if necessary. However, in most cases, the down time (for instance, overnight) is sufficient to allow charging the mobile charging stations in series (up to a certain length), especially if a dedicated cooling system is used at the fixed charging point (for instance the liquid coolant as discussed).

The predetermined schedule can be varied, depending on circumstances, and can even be dynamically switched. The schedule can for instance be one or more of the following:
prioritize least charged station in the series: transferred energy can be cascaded to a subsequent station until it reaches the least charged station in the series, which does not charge the subsequent station as long as it is the least charged in the series;
partial transfer to subsequent stations: transferred energy is partially (X %) be cascaded to a subsequent mobile charging station, and so on;
last station (furthest away from the fixed charging point) is charged as highest priority, to ensure that the first station to be used is charged fully;
first station (directly connected to the fixed charging point) is charged as highest priority, as this will usually be the one that is closest to full;
prioritize a specifically designated station;
etc.

The invention is further described by the following non-limiting examples which further illustrate the invention, and are not intended to, nor should they be interpreted to, limit the scope of the invention.

### EXAMPLES AND/OR DESCRIPTION OF FIGURES

FIG. 1 shows a schematic representation of a preferred embodiment of the invention. It is to be considered that the skilled person will acknowledge that the number of elements used can easily be variated, for instance, adding additional battery packs, more than one converter units, etc., and as such, variations according to the same principles form part of the disclosed invention implicitly.

The mobile charging station (100) comprises a battery pack or energy accumulation group (110), comprising one or more accumulators (111), and a battery management unit or BMU (112). In this embodiment, certain requirements are imposed on the energy accumulation group, such as a minimal power (and/or maximal) and others, which can be modified depending on the specific application context and requirements (for instance, reducing charging time, increasing charge capacity for longer deployment of the charging station, etc.). The charging station (100) further comprises a converter unit (120) connected to the battery pack (110), and specifically to the BMU (112), which converts the voltage from the battery pack (110) from a first voltage (of the battery pack) to a desired voltage for charging an electric vehicle (200).

Electric vehicles (200) are connectable to the mobile charging station (100) via a connector (150), which is preferably removable from the charging station (100). This interfaces with a station charge controller (130) which allows communication with the electric vehicle (200), and upon detection of an established connection to an electric vehicle (200), controls the battery pack (110) and converter unit (120) to charge the electric vehicle (200) via the connector (150).

Additionally, the mobile charging station (100) comprises an EV charge controller (140), which can interface with external charging points (300) via a connector (160). Such external charging points are for instance stationary charging stations for electric vehicles in tank stations, or in the street. The EV charge controller (140) can interact with the external charging point (300), and specifically communicate to the external charging point (300) that it can recharge the mobile charging station (100).

It should be noted that in some embodiments, the connectors (150, 160) are the same, while in others, two separate connectors (150, 160) are employed.

FIG. 2 shows a general representation of the mobile charging station (100) in use while charging an electric vehicle (200), connected via a connector (150).

The present invention is in no way limited to the embodiments described in the examples and/or shown in the figures. On the contrary, methods according to the present invention may be realized in many different ways without departing from the scope of the invention.

1. A mobile charging station, configured to charge one or more electric vehicles (EVs), comprising:
an energy accumulation group, comprising accumulators for storing energy, and a dedicated accumulator management system;
a converter unit, connected to a direct-current (DC) bus and said accumulators, comprising one or more DC-DC converters, for converting a source of direct current from a first voltage level to a second voltage level, the second voltage level different from the first voltage level, whereby a dedicated control system, connected to said converter unit, is adapted to control the operation of said converter unit;
a station charge controller, whereby said station charge controller is configured as a communication module between said EV and said accumulator management system, whereby said station charge controller reads data from said EVs and/or writes data to said EVs and thereby allows said mobile charging station to recharge said EV; and;
one or more interfaces, connected to said station charge controller, whereby said interface is configured for connecting a DC charging plug;
characterized in that said mobile charging station further comprises an EV charge controller, whereby said EV charge controller is connected to said interface, whereby said EV charge controller functions as a communication module between an external charging point and said converter unit, whereby said EV charge controller reads data from said external charging point and/or writes data to said external charging point, and thereby prompting said external charging point to recharge said mobile charging station based on said data,
wherein the charging station comprises a heat management system for cooling at least the energy accumulation group, wherein said energy accumulation group comprises a niobium-titanium and/or lithium-titanium based battery.

2. The mobile charging station according to claim 1, whereby said converter unit is configured to enable bidirectional charging, whereby either said energy accumulation group is charged by said external charging point or said energy accumulation group is discharged by said EV.

3. The mobile charging station according to claim 1, whereby said charging station comprises one or more switches whereby each switch is respectively connectable to said interface and to said direct-current bus, whereby said switches are configured to isolate or link said direct-current bus from said interfaces and whereby each switch is respectively controllable by said station charge controller or said EV charge controller.

4. The mobile charging station according to claim 1, whereby said interface is configured to receive a DC connector plug, and whereby said connector plug is connectable to said EV or said external charger.

5. The mobile charging station according to claim 1, whereby said energy accumulation group comprises a lithium-titanate (LTO) battery and/or a niobium-titanate (NTO) battery.

6. The mobile charging station according to claim 1, whereby said charging station is configured for charging at a power rate of minimum 50 kW DC and whereby said charging station is configured as a direct-current fast charger (DCFC).

7. (canceled)

8. The mobile charging station according to claim 1, whereby said heat management system comprises a heat-extraction ventilator.

9. The mobile charging station according to claim 1, whereby said charging station comprises an interconnection recipient, whereby multiple charging stations are connectable in parallel by interconnecting said interconnection recipient from two or more of the multiple charging stations and whereby said charging stations can be charged simultaneously.

10. The mobile charging station according to claim 1, whereby multiple of said mobile charging stations are connectable in series, wherein when the multiple of said mobile charging stations are connected, the mobile charging station with the least charged energy accumulation group is charged by at least one other mobile charging station of said mobile charging stations.

11-13. (canceled)

14. The mobile charging station according to claim 1, wherein the converter unit comprises Silicon-Carbide (SiC) switching technology.

15. The mobile charging station according to claim 1, wherein the station comprises an internal cooling circuit for circulating a liquid coolant, wherein said internal cooling circuit contacts at least a heat sink of the energy accumulation group, wherein the internal cooling circuit comprises a coolant inlet port and a coolant outlet port on the exterior of the mobile charging station.

16. The mobile charging station according to claim 1, wherein the heat management system is configured for creating an air flow from outside of the mobile charging station, wherein the air flow enters the mobile charging station at a position at or near the bottom of the mobile charging station.

17. The mobile charging station according to claim 1, wherein the mobile charging station comprises an outer frame and wherein all internal components are housed in a plurality of closed subframes, said outer frame housing a first closed subframe comprising the converter unit, a second closed subframe comprising the energy accumulation group, a third closed subframe comprising the station charge controller and the EV charge controller, and a fourth closed subframe comprising the one or more interfaces, wherein the closed subframes comprise one or more connectors and wherein each closed subframe is wiredly connected to at least one other of the closed subframes via said connectors.

18. The mobile charging station according to claim 1, wherein the mobile charging station comprises a control system configured for controlling charge speed of charging an EV, wherein the control system is configured for determining the charge speed based on at least the following features: an internal temperature of the mobile charging station; an increase rate in the internal temperature; and a charge plan, comprising information on the amount of EVs to be charged in a predetermined time span, the amount of energy to be charged per EV to be charged; wherein the charge speed is modified to maintain the internal temperature below a predefined maximum temperature over the predetermined time span.

19. A method for operating said mobile charging station according to claim 1, comprising the following steps:
automatically assigning said mobile charging station to an electric vehicle;
transporting said mobile charging station to said electric vehicle, and charging said electric vehicle;
retrieving information regarding available proximal charging points, said information comprising location and availability of said charging points;
recharging said mobile charging station;
wherein said mobile charging station is recharged at one of said charging points.

20. The method according to claim 19, whereby said mobile charging station is recharged at a central charging hub, based on at least the distance between the location of said mobile charging station, the location of said charging points, the location of said central charging hub and the location of a possible next charging session.

21. (canceled)

22. A method for recharging said mobile charging station according to claim 1, wherein the station comprises an internal cooling circuit for circulating a liquid coolant, wherein said internal cooling circuit contacts at least a heat sink of the energy accumulation group, wherein the internal cooling circuit comprises a coolant inlet port and a coolant outlet port on the exterior of the mobile charging station, wherein the method further comprises:
electrically connecting the mobile charging station to a fixed charging point;
connecting the coolant inlet port and the coolant outlet port to a coolant supply system of the fixed charging point;
recharging the energy accumulation group of the mobile charging station by the fixed charging point;
circulating a refrigerated coolant by the coolant supply system through the internal cooling circuit;
removing coolant from the internal cooling circuit and subsequently disconnecting the coolant inlet port and the coolant outlet port from the coolant supply system; and
disconnecting the mobile charging station from the fixed charging point.

23. A method for scheduledly charging a plurality of electric vehicles (EVs) with said mobile charging station according to claim 1, comprising the steps of:
electrically connecting the mobile charging station to a first of the EVs;
recharging the first of the EVs by the mobile charging station according to an optimized charge speed;
wherein the optimized charge speed is determined based on at least the following features: an internal temperature of the mobile charging station; an increase rate in the internal temperature; and a charge plan, comprising information on the plurality of EVs to be charged in a predetermined time span and the amount of energy to be charged per EV to be charged;
wherein the optimized charge speed is modified to maintain the internal temperature below a predefined maximum temperature over the predetermined time span.

24. A method for charging a plurality of said mobile charging stations according to claim 1 at a fixed charging point, the method comprising the steps of:
connecting the plurality of the mobile charging stations in series with each other, with the first mobile charging station in the series being connected to the fixed charging point; and
charging the plurality of the mobile charging stations in the series according to a predetermined schedule, wherein the first mobile charging station is charged by the charging point, and wherein one or more of the mobile charging stations charge subsequent mobile charging station in the series, departing from the charging point, according to the predetermined schedule.

25. The method according to claim 24, wherein the mobile charging station with the least charged energy accumulation group does not charge the subsequent mobile charging station.
